(19) United States
(12) Patent Application Publication
(10) Pub. No.: US 2023/0174378 A1
(43) Pub. Date: Jun. 8, 2023

(54) PROCESS FOR PRODUCING HYDROGEN

(71) Applicant: JOHNSON MATTHEY PUBLIC LIMITED COMPANY, London (GB)

(72) Inventors: William John COTTON, Billingham, Cleveland (GB); Mark Joseph MCKENNA, Billingham, Cleveland (GB); Majid SADEQZADEH BOROUJENI, Billingham, Cleveland (GB)

(21) Appl. No.: 17/997,968

(22) PCT Filed: Jun. 4, 2021
(86) PCT No.: PCT/GB2021/051394

§ 371 Date: Nov. 7, 2022

(30) Foreign Application Priority Data
Jun. 30, 2020 (GB) 2009969.3

(51) Int. Cl. C01B 3/48; C01B 3/36; C01B 3/50

(52) U.S. Cl. CPC C01B 3/48; C01B 3/36; C01B 3/50; C01B 2203/0233; C01B 2203/0283; C01B 2203/0415; C01B 2203/0475; C01B 2203/0844; C01B 2203/1241; C01B 2203/062

(57) ABSTRACT

A process for the production of hydrogen comprising the steps of subjecting a gaseous mixture comprising a hydrocarbon and steam and having a steam to carbon ratio of at least 2.6:1, to steam reforming in a gas-heated reformer followed by autothermal reforming with an oxygen-rich gas in an autothermal reformer to generate a reformed gas mixture, increasing the hydrogen content of the reformed gas mixture by subjecting it to one or more water-gas shift stages in a water-gas shift unit to provide a hydrogen-enriched reformed gas, cooling the hydrogen-enriched reformed gas and separating condensed water therefrom, passing the resulting de-watered hydrogen-enriched reformed gas to a carbon dioxide separation unit to provide a carbon dioxide gas stream and a crude hydrogen gas stream, and passing the crude hydrogen gas stream to a purification unit to provide a purified hydrogen gas and a fuel gas.

This invention relates to processes for the conversion of hydrocarbons to hydrogen whilst minimising carbon dioxide production and emission.

Processes for generating hydrogen are well-known and generally include a fired steam methane reformer combined with water-gas shift and carbon dioxide (CO₂) removal. Such processes create significant volumes of carbon dioxide in flue gases at pressures unsuitable for efficient CO₂ capture. There is a need for hydrogen production processes that generate lower levels of carbon dioxide effluent and enable more efficient CO₂ capture.

A process for low-carbon hydrogen is disclosed in an article published in The Chemical Engineer, (15 Mar. 2019) entitled “Clean Hydrogen. Part 1: Hydrogen from Natural Gas through Cost Effective CO2 Capture”. The process disclosed in the article comprised steps of desulphurisation, saturation, reforming in a gas-heated reformer and oxygen-fed autothermal reformer, isothermal temperature shift, cooling, condensate removal and pressure swing adsorption. The percentage of CO₂ captured was 95.4% for the LCH process.

We have developed an improved process where the percentage of CO₂ captured may be about 97% or higher.

Accordingly, the invention provides a process for the production of hydrogen comprising the steps of:
(i) subjecting a gaseous mixture comprising a hydrocarbon and steam and having a steam to carbon ratio of at least 2.6:1 to steam reforming in a gas-heated reformer followed by autothermal reforming with an oxygen-rich gas in an autothermal reformer to generate a reformed gas mixture,
(ii) increasing the hydrogen content of the reformed gas mixture by subjecting it to one or more water-gas shift stages in a water-gas shift unit to provide a hydrogen-enriched reformed gas,
(iii) cooling the hydrogen-enriched reformed gas and separating condensed water therefrom,
(iv) passing the resulting de-watered hydrogen-enriched reformed gas to a carbon dioxide separation unit to provide a carbon dioxide gas stream and a crude hydrogen gas stream, and
(v) passing the crude hydrogen gas stream to a purification unit to provide a purified hydrogen gas and a fuel gas,

wherein the fuel gas is fed, as the sole fuel, to one or more fired heaters used to heat one or more process streams within the process.

By using a gas-heated reformer coupled to the autothermal reformer in series and operating at the selected steam to carbon ratio it is possible to use the fuel gas as the sole fuel for the one or more fired heaters and thereby minimise CO₂ emissions from the process. Further efficiency enhancements are also possible, thereby enabling 97% or higher CO₂ capture from the process.

The gaseous mixture may comprise any gaseous or low boiling hydrocarbon, such as natural gas, associated gas, LPG, petroleum distillate, diesel, naphtha or mixtures thereof, or hydrocarbon-containing off-gases from chemical processes, such as a refinery off-gas or a pre-reformed gas. The gaseous mixture preferably comprises methane, associated gas or natural gas containing a substantial proportion, e.g. over 50% v/v methane. Natural gas is especially preferred. The hydrocarbon may be compressed to a pressure in the range 10-100 bar abs. The pressure of the hydrocarbon may usefully govern the pressure throughout the process. Operating pressure is preferably in the range 15-50 bar abs, more preferably 25-50 bar abs as this provides an enhanced performance from the process.

If the hydrocarbon contains sulphur compounds, before, or preferably after, compression it may be subjected to desulphurisation comprising hydrodesulphurisation using CoMo or NiMo catalysts, and absorption of hydrogen sulphide using a suitable hydrogen sulphide adsorbent, e.g. a zinc oxide adsorbent. An ultra-purification adsorbent may usefully be used downstream of the hydrogen sulphide adsorbent to further protect the steam reforming catalyst. Suitable, ultra-purification adsorbents may comprise copper-zinc oxide/alumina materials and copper-nickel-zinc oxide/alumina materials. To facilitate hydrodesulphurisation and/or reduce the risk of carbon laydown in the reforming process, hydrogen is preferably added to the compressed hydrocarbon. The amount of hydrogen in the resulting mixed gas stream may be in the range 1-20% vol, but is preferably in the range 1-10% vol, more preferably in the range 1-5% vol on a dry gas basis. In a preferred embodiment, a portion of the crude or purified hydrogen gas stream may be mixed with the compressed hydrocarbon. Hydrogen may be combined with the hydrocarbon upstream and/or downstream of any hydrodesulphurisation stage.

If the hydrocarbon contains other contaminants, such as chloride or heavy metal contaminants, these may be removed, prior to reforming, upstream or downstream of any desulphurisation, using conventional adsorbents. Adsorbents suitable for chloride removal are known and include alkalised alumina materials. Similarly, adsorbents for heavy metals such as mercury or arsenic are known and include copper sulphide materials.

The hydrocarbon may be pre-heated. It may conveniently be pre-heated after compression and before desulphurisation. Various hot gas sources are provided in the present process that may be used for this duty. However, in a preferred embodiment, the hydrocarbon is heated by passing it through a fired heater fuelled by at least a portion of the fuel gas.

The hydrocarbon is mixed with steam. The steam introduction may be performed by direct injection of steam and/or by saturation of the hydrocarbon by contact with a stream of heated water. In a preferred embodiment, the hydrocarbon is saturated in a saturator fed with hot water to form a saturated gas mixture. The water preferably comprises one or more of the condensate streams recovered from the hydrogen-enriched reformed gas, water recovered from the bottom of the saturator, and other condensate produced in the process. The steam content of the saturated gas mixture may, if desired, be increased by the direct addition of steam. The amount of steam introduced is sufficient to give a steam to carbon ratio at the inlet to the reforming unit operations of at least 2.6:1, i.e. at least 2.6 moles of steam per gram atom of hydrocarbon carbon in the gaseous mixture. Because of the efficient utilisation of energy in the process, the steam to carbon ratio may be high, which maximises hydrogen production. The steam to carbon ratio may usefully be up to about 3.5:1. It is preferred that the steam to carbon ratio is in the range 2.8:1 to 3.5:1, especially 2.9:1 to 3.2:1 or 3.2:1 to 3.5:1 as this provides an optimal balance of hydrogen production and efficiency to minimise CO₂ emissions.

The gaseous mixture comprising hydrocarbon and steam is then desirably pre-heated prior to reforming. In a preferred embodiment, the gaseous mixture is heated by passing it through a fired heater fuelled by at least a portion of the fuel gas, in particular through the same fired heater used to pre-heat the hydrocarbon. Desirably, the mixed stream is heated to 400-500° C., preferably 420-460° C.

Although not generally necessary for light gaseous hydrocarbons feedstocks, where hydrocarbon feedstocks contain higher hydrocarbons, it may be preferable in some instances to include a stage of adiabatic pre-reforming upstream of the gas-heated reformer. The gaseous mixture comprising the hydrocarbon and steam in these cases is first subjected to a step of adiabatic steam reforming in a pre-reformer vessel. In such a process, the gaseous mixture comprising the hydrocarbon and steam, typically at an inlet temperature in the range of 400-650° C., is passed adiabatically through a bed of a steam reforming catalyst, usually a steam reforming catalyst having a high nickel content, for example above 40% by weight. During such an adiabatic pre-reforming step, any hydrocarbons higher than methane react with steam to give a mixture of methane, carbon oxides and hydrogen. The use of such an adiabatic steam reforming step, commonly termed pre-reforming, can be desirable to ensure that the feed to the gas-heated reformer contains no hydrocarbons higher than methane and also contains some hydrogen.

The gaseous mixture comprising the hydrocarbon and steam is subjected to steam reforming in a gas-heated reformer and autothermal reforming in an autothermal reformer. The gas-heated reformer and the autothermal reformer are operated in series.

In one type of gas-heated reformer, the catalyst is disposed in tubes extending between a pair of tube sheets through a heat exchange zone. Reactants are fed to a zone above the upper tube sheet and pass through the tubes and into a zone beneath the lower tube sheet. The heating medium is passed through the zone between the two tube sheets. Gas-heated reformers of this type are described in GB1578 270 and WO97/05 947. Another type of gas-heated reformer that may be used is a double-tube gas-heated reformer as described in U.S. Pat. No. 4,910,228 wherein the reformer tubes each comprise an outer tube having a closed end and an inner tube disposed concentrically within the outer tube and communicating with the annular space between the inner and outer tubes at the closed end of the outer tube with the steam reforming catalyst disposed in said annular space. The external surface of the outer tubes is heated by the autothermally reformed gas. The reactant mixture is fed to the end of the outer tubes remote from said closed end so that the mixture passes through said annular space and undergoes steam reforming and then passes through the inner tube.

The compressed, pre-heated gaseous mixture comprising the hydrocarbon and steam is passed through the catalyst-filled tubes in the gas-heated reformer. During passage through the reforming catalyst, the endothermic steam reforming reaction takes place with the heat required for the reaction being supplied from the autothermally reformed gas flowing past the exterior surface of the tubes. The steam reforming catalyst used in the gas-heated reformer may comprise nickel supported on a particulate refractory support such as rings or multi-holed pellets of calcium aluminate, magnesium aluminate, alumina, titania, zirconia and the like.

Alternatively, a combination of nickel and a precious metal such as ruthenium, may be used. In place of, or in addition to, the particulate steam reforming catalyst, the steam reforming catalyst may comprise one or more structured catalyst units, which may be in the form of metal or ceramic monoliths or folded metal structures on which a layer of nickel and/or precious metal steam reforming catalyst has been deposited. Such structured catalysts are described for example in WO2012/103432 A1 and WO2013151885 (A1).

The temperature of the autothermally reformed gas used to heat the gas-heated reformer is preferably sufficient that the gas undergoing steam reforming leaves the catalyst tubes at a temperature in the range 600-850° C., preferably 650-750° C., more preferably 680-720° C. In the present invention the steam reformed gas, which comprises methane, hydrogen, steam and carbon oxides, is fed preferably without any dilution or heat exchange, directly to an autothermal reformer in which it is subjected to autothermal reforming, also termed secondary reforming. The steam reforming in the gas-heated reformer may be therefore termed primary reforming.

The autothermal reformer may comprise a burner disposed at the top of the reformer, to which the steam reformed gas and the oxygen-rich gas are fed, a combustion zone beneath the burner through which a flame extends, and a fixed bed of particulate steam reforming catalyst disposed below the combustion zone. In autothermal reforming, the heat for the endothermic steam reforming reactions is therefore provided by combustion of a portion of hydrocarbon in the feed gas. The steam reformed gas is typically fed to the top of the reformer and the oxygen-rich gas fed to the burner, mixing and combustion occur downstream of the burner generating a heated gas mixture the composition of which is brought to equilibrium as it passes through the steam reforming catalyst. The autothermal steam reforming catalyst may comprise nickel supported on a refractory support such as rings or pellets of calcium aluminate, magnesium aluminate, alumina, titania, zirconia and the like. In a preferred embodiment, the autothermal steam reforming catalyst comprises a layer of a catalyst comprising Ni and/or Ru on zirconia over a bed of a Ni on alumina catalyst to reduce catalyst support volatilisation that can result in deterioration in performance of the autothermal reformer.

The oxygen-rich gas may comprise at least 50% vol O₂ and may be an oxygen-enriched air mixture. However, in the present invention the oxygen-rich gas preferably comprises at least 90% vol O₂, more preferably at least 95% vol O₂, most preferably at least 98% vol O₂, or at least 99% vol O₂, e.g. a pure oxygen gas stream, which may be obtained using a vacuum pressure swing adsorption (VPSA) unit or an air separation unit (ASU). The ASU may be electrically driven and is desirably driven using renewable electricity to further improve the efficiency of the process and minimise CO₂ emissions.

The amount of oxygen-rich gas added is preferably such that 40 to 60 moles of oxygen are added per 100 moles of carbon in the hydrocarbon fed to the process. Preferably the amount of oxygen added is such that the reformed gas leaves the catalyst in the autothermal reformer at a temperature in the range 800-1100° C., more preferably 900-1100° C., most preferably 970-1070° C. In a preferred embodiment, a small purge of steam may be added to the oxygen-rich gas to protect against reverse flow if the plant trips.

The reformed gas produced by the autothermal reformer is used to provide the heat required for the primary steam reforming step by using it as the hot gas flowing past the tubes in the gas-heated reformer. During this heat exchange, the reformed gas cools by transferring heat to the gas undergoing steam reforming. Preferably the reformed gas cools by several hundred degrees Centigrade but it will leave the gas-heated reformer at a temperature somewhat above the temperature at which the gaseous mixture comprising hydrocarbon and steam mixture is fed to the gas-heated reformer. Preferably the reformed gas leaves the gas-heated reformer at a temperature in the range 450-650° C., more preferably 450-580° C.

After leaving the gas-heated reformer, the reformed gas is then further cooled in one or more steps of heat exchange. Heat recovered during this cooling may be employed for reactants pre-heating and/or for heating water used to provide the steam employed in the steam reforming step. As described hereinafter, the recovered heat may additionally, or alternatively, be used in the carbon dioxide separation step. In a preferred embodiment, the reformed gas mixture exiting the shell side of the gas-heated reformer is used to heat water fed to a saturator.

The reformed gas comprises hydrogen, carbon monoxide, carbon dioxide, steam, and a small amount of unreacted methane, and may also contain small amounts of inert gases such as nitrogen and argon. Preferably, the hydrogen content of the reformed gas is in the range 30-45% vol and the carbon monoxide content in the range 5-15% vol. In the present invention, the hydrogen content of the partially cooled reformed gas mixture is increased by subjecting it to one or more water-gas shift stages thereby producing a hydrogen-enriched reformed gas and at the same time converting carbon monoxide in the reformed gas to carbon dioxide. The reaction may be depicted as follows;

CO+H₂O↔CO₂+H₂

Because steam reforming is performed with an excess of steam it is generally not necessary to add steam to the reformed gas mixture recovered from the autothermal reformer to ensure sufficient steam is available for the water-gas shift reaction. However, supplemental steam may be added if desired.

The partially cooled reformed gas may be subjected in the water-gas shift unit to one or more water-gas shift stages to form a hydrogen-enriched reformed gas stream, or “shifted” gas stream. The one or more water-gas shift stages may include stages of high-temperature shift, medium-temperature shift, isothermal shift and low-temperature shift.

High-temperature shift is operated adiabatically in a shift vessel with inlet temperature in the range 300-400° C., preferably 320-360° C., over a bed of a reduced iron catalyst, such as chromia-promoted magnetite. Alternatively, a promoted zinc-aluminate catalyst may be used.

Medium-temperature shift and low-temperature shift stages may be performed using shift vessels containing supported copper-catalysts, particularly copper/zinc oxide/alumina compositions. In low-temperature shift, a gas containing carbon monoxide (preferably ≤6% vol CO on a dry basis) and steam (at a steam to total dry gas molar ratio in range 0.3 to 1.5) may be passed over the catalyst in an adiabatic fixed bed with an outlet temperature in the range 200 to 300° C. The outlet carbon monoxide content may be in the range 0.1 to 1.5%, especially under 0.5% vol on a dry basis if additional steam is added. Alternatively, in medium-temperature shift, the gas containing carbon monoxide and steam may be fed to the catalyst at an inlet temperature in the range 200 to 240° C. although the inlet temperature may be as high as 280° C. The outlet temperature may be up to 300° C. but may be as high as 360° C.

Whereas one or more adiabatic water-gas shift stages may be employed, such as a high-temperature shift stage, optionally followed by a low-temperature shift stage, the partially cooled reformed gas is preferably subjected to a stage of isothermal water-gas shift in a cooled shift vessel, optionally followed by one or more adiabatic medium- or low-temperature water-gas shift stages in un-cooled vessels as described above. Using an isothermal shift stage, i.e. with heat exchange in the shift converter such that the exothermic reaction in the catalyst bed occurs in contact with heat exchange surfaces that remove heat, offers the potential to use the reformed gas stream in a very efficient manner. Whereas the term “isothermal” is used to describe a cooled shift converter, there may be a small increase in temperature of the gas between inlet and outlet, so that the temperature of the hydrogen-enriched reformed gas stream at the exit of the isothermal shift converter may be between 1 and 25 degrees Celsius higher than the inlet temperature. The coolant conveniently may be water under pressure such that partial, or complete, boiling takes place. The water can be in tubes surrounded by catalyst or vice versa. The resulting steam can be used, for example, to drive a turbine, e.g. for electrical power, or to provide process steam for supply to the process. In a preferred embodiment, steam generated by the isothermal shift stage is used to supplement the steam addition to the gaseous mixture comprising a hydrocarbon and steam upstream of the gas-heated reformer. This improves the efficiency of the process and enables the relatively high steam to carbon ratio to be achieved at low cost.

Addition of an adiabatic medium- or low-temperature shift stage downstream of the isothermal shift stage offers the potential to increase the CO₂ capture efficiency from the process to 98% or higher. However, we have found that excellent efficiency may be provided by a single isothermal shift converter.

Following the one or more shift stages, the hydrogen-enriched reformed gas is cooled to a temperature below the dew point so that the steam condenses. The liquid water condensate may then be separated using one or more, gas-liquid separators, which may have one or more further cooling stages between them. Any coolant may be used. Preferably, cooling of the hydrogen-enriched reformed gas stream is first carried out in heat exchange with the process condensate. As a result, a stream of heated water, which may be used to supply some or all of the steam required for reforming, is formed. Thus, in one embodiment condensate recovered from the hydrogen-enriched reformed gas is used to provide at least a portion of steam for the gas mixture fed to the steam reforming step in the gas-heated reformer. Because the condensate may contain ammonia, methanol, hydrogen cyanide and CO₂, returning the condensate to form steam offers a useful way of returning hydrogen and carbon to the process.

One or more further stages of cooling are desirable. The cooling may be performed in heat exchange in one or more stages using demineralised water, air, or a combination of these. In a preferred embodiment, cooling is performed in heat exchange with one or more liquids in the CO₂ separation unit. In a particularly preferred arrangement, the hydrogen-enriched reformed gas stream is cooled in heat exchange with condensate followed by cooling with CO₂ reboiler liquid. The cooled shifted gas may then be fed to a first gas-liquid separator, the separated gas further cooled with water and/or air and fed to a second separator, before further cooling with water and/or air and feeding to a third separator. Two or three stages of condensate separation are preferred. Some or all of the condensate may be used to generate steam for the steam reforming. Any condensate not used to generate steam may be sent to water treatment as effluent.

Typically, the hydrogen-enriched reformed gas stream contains 10 to 30% vol of carbon dioxide (on a dry basis). In the present invention, after separation of the condensed water, carbon dioxide is separated from the resulting de-watered hydrogen-enriched reformed gas stream.

The carbon dioxide separation stage may be performed using a physical wash system or a reactive wash system, preferably a reactive wash system, especially an amine wash system. The carbon dioxide may be separated by an acid gas recovery (AGR) process. In the AGR process the de-watered hydrogen-enriched reformed gas stream (i.e. the de-watered shifted gas) is contacted with a stream of a suitable absorbent liquid, such as an amine, particularly methyl diethanolamine (MDEA) solution so that the carbon dioxide is absorbed by the liquid to give a laden absorbent liquid and a gas stream having a decreased content of carbon dioxide. The laden absorbent liquid is then regenerated by heating and/or reducing the pressure, to desorb the carbon dioxide and to give a regenerated absorbent liquid, which is then recycled to the carbon dioxide absorption stage. Alternatively, methanol or a glycol may be used to capture the carbon dioxide in a similar manner as the amine. In a preferred arrangement, at least part of this heating is in heat exchange with the hydrogen-enriched reformed gas stream.

If the carbon dioxide separation step is operated as a single pressure process, i.e. essentially the same pressure is employed in the absorption and regeneration steps, only a little recompression of the recycled carbon dioxide will be required.

The recovered carbon dioxide, e.g. from the AGR, may be compressed and used for the manufacture of chemicals, or sent to storage or sequestration or used in enhanced oil recovery (EOR) processes. Compression may be accomplished using an electrically driven compressor powered by renewable electricity. In cases where the CO₂ is to be compressed for storage, transportation, use in EOR processes or conversion to other chemical products, the CO₂ may be dried to prevent liquid water present in trace amounts, from condensing. For example, the CO₂ may be dried to a dew point ≤−10° C. by passing it through a bed of a suitable desiccant, such as a zeolite, or contacting it with a glycol in a glycol drying unit.

Upon the separation of the carbon dioxide, the process provides a crude hydrogen gas stream. The crude hydrogen stream may comprise 90-99% vol hydrogen, preferably 95-99% vol hydrogen with the balance comprising methane, carbon monoxide, carbon dioxide and inert gases. The methane content may be in the range 0.25-1.5% vol, preferably 0.25-0.5% vol. The carbon monoxide content may be in the range 0.5-2.5% vol, preferably 0.5-1.0% vol. The carbon dioxide content may be in the range 0.01-0.5% vol, preferably 0.01-0.1% vol. Whereas this hydrogen gas stream may be pure enough for many duties, in the present invention, the crude hydrogen gas stream is passed to a purification unit to provide a purified hydrogen gas and a fuel gas, so that the fuel gas may be used in the process as an alternative to external fuel sources in order to minimise the CO₂ emissions from the process.

The purification unit may suitably comprise a membrane system, a temperature swing adsorption system, or a pressure swing adsorption system. Such systems are commercially available. The purification unit is preferably a pressure swing adsorption unit. Such units comprise regenerable porous adsorbent materials that selectively trap gases other than hydrogen and thereby purify it. The purification unit produces a pure hydrogen stream preferably with a purity greater than 99.5% vol, more preferably greater than 99.9% vol, which may be compressed and used in downstream power or heating process, for example, by using it as fuel in a gas turbine (GT) or by injection into a domestic or industrial networked gas piping system. The pure hydrogen may also be used in a downstream chemical synthesis process. Thus, the pure hydrogen stream may be used to produce ammonia by reaction with nitrogen in an ammonia synthesis unit. Alternatively, the pure hydrogen may be used with a carbon dioxide-containing gas to manufacture methanol in a methanol production unit. Alternatively, the pure hydrogen may be used with a carbon-monoxide containing gas to synthesise hydrocarbons in a Fischer-Tropsch production unit. Any known ammonia, methanol or Fischer-Tropsch production technology may be used. Alternatively, the hydrogen may be used to upgrade hydrocarbons, e.g. by hydro-treating or hydro-cracking hydrocarbons in a hydrocarbon refinery, or in any other process where pure hydrogen may be used. Compression may again be accomplished using an electrically driven compressor powered by renewable electricity.

A portion of the crude hydrogen or a portion of the pure hydrogen may be compressed if necessary and recycled to the hydrocarbon feed if desired for desulphurisation and to reduce the potential for carbon formation on the catalyst in the gas-heated reformer.

The hydrogen purification unit desirably operates with continual separation of the fuel gas from the crude hydrogen stream. The combination of steam reforming in a gas-heated reformer and autothermal reforming in an autothermal reformer with the claimed steam to carbon ratio provides sufficient fuel gas to heat the process streams used in the process without the need for additional fuel addition to the process. Thus, in the present invention, the fuel gas may be the sole fuel used in the one or more fired heaters used to heat process streams.

The fuel gas composition depends on the extent of the purification of the crude hydrogen stream. The fuel gas stream may comprise 80-90% vol hydrogen, preferably 85-90% vol hydrogen with the balance comprising methane, carbon monoxide, carbon dioxide and inert gases. The methane content may be in the range 1-5% vol, preferably 2-5% vol. The carbon monoxide content may be in the range 2-10% vol, preferably 2-8% vol. The carbon dioxide content may be in the range 0-1% vol, preferably 0.1-0.5% vol.

In some circumstances, such as during start-up of the process, it may be necessary to supplement the fuel gas with a hydrocarbon fuel temporarily, but this should not materially reduce the efficiency of the process, and during normal operation the fuel gas recovered from the purification unit will be the sole fuel provided to the one or more fired heaters.

Whereas all the process streams requiring heating may be heated in a single fired heater, in a preferred arrangement one fired heater is used for process gas streams containing hydrocarbon and/or hydrogen and another is used solely for steam generation. The latter fired heater may therefore also be described as a boiler. The fuel gas may therefore be divided between a first fired heater used to heat hydrocarbon-containing and/or hydrogen-containing streams and a second fired heater used to boil water to generate steam. Using two fired heaters in this way provides a number of distinct advantages; it allows for steam to be raised within the second fired heater and thereby used as part of the plant start-up; it allows steam to be generated in the second fired heater whilst the plant is being shut down and supplied to the plant during the shut-down process; it makes start-up easier as the first and second fired heaters can be operated independently and eliminates coils being heated in a no-flow regime; and separating the first fired heater allows nitrogen to be warmed up as part of the start-up procedure whilst the second fired heater is either being brought into service or is itself being started up. The fuel gas split to the first and second fired heaters may be in the ranges of 10-90% vol to 90-10% vol respectively but is preferably 40-50% vol to the first fired heater and 60-50% vol to the second fired heater.

Both saturated and superheated steam may be produced in the one or more fired heaters. In one embodiment, a portion of the steam generated in the second fired heater is fed to the hydrocarbon feed to the gas-heated reformer. In this way the high steam to carbon ratio may be more readily achieved. Steam generated in the second fired heater may also be provided via the steam drum coupled to the isothermal shift converter. In one preferred arrangement, the entire steam for the process is generated by a combination of the saturator, the second fired heater and by a steam drum coupled to an isothermal shift converter. In this arrangement, the saturator may generate 50-60% or 55-65% of the steam, the second fired heater raises 20-25% of the steam and the steam drum coupled to the isothermal shift converter raises the balance.

The invention is illustrated by reference to the accompanying drawing in which:

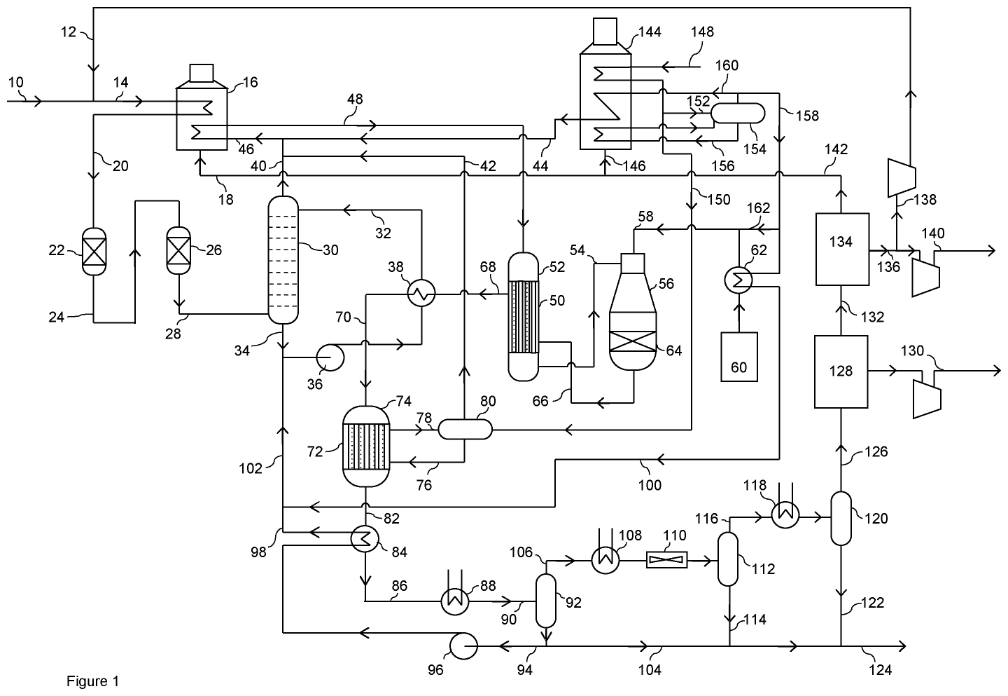

FIG. 1 is a diagrammatic flowsheet of one embodiment of the invention.

It will be understood by those skilled in the art that the drawings are diagrammatic and that further items of equipment such as reflux drums, pumps, vacuum pumps, temperature sensors, pressure sensors, pressure relief valves, control valves, flow controllers, level controllers, holding tanks, storage tanks, and the like may be required in a commercial plant. The provision of such ancillary items of equipment forms no part of the present invention and is in accordance with conventional chemical engineering practice.

In FIG. 1 a natural gas stream comprising >85% vol methane fed via line 10 is mixed with a hydrogen-containing stream 12 such that the resulting process gas mixture contains between 1 and 5% vol hydrogen. The hydrogen-containing natural gas stream is fed via line 14 to a first fired heater 16, where it is heated by combustion of a fuel gas fed via line 18. The heated natural gas mixture is then desulphurised by passing it via line 20 to a hydrodesulphurisation (HDS) vessel 22 containing a bed of hydrodesulphurisation catalyst, where organic sulphur compounds present in the natural gas are converted with the hydrogen to hydrogen sulphide, and then via line 24 to a vessel 26 containing a bed of zinc oxide adsorbent and a bed of a copper-zinc-alumina ultra-purification adsorbent that remove hydrogen sulphide.

The desulphurised natural gas is fed from the vessel 26 via line 28 to a saturator vessel 30 where it is passed counter-currently upwards against a stream of heated pressurised water fed to near the top of the saturator via line 32. The natural gas becomes saturated with steam as it passes through the saturator vessel 30. Water is recovered from the base of the saturator 30 via line 34, combined with a heated condensate and steam condensate formed elsewhere in the process, and recirculated via pump 36 to a heat exchanger 38, where it is heated before being returned to the saturator via line 32. The saturated desulphurised natural gas is recovered from the top on the saturator vessel 30 via line 40 and combined with steam fed via lines 42 and 44 to provide a steam to carbon ratio at the inlet to reforming unit operations of about 3.1:1.

The saturated desulphurised natural gas and steam mixture is fed via line 46 to the fired heater 16 where it is further heated before being fed from the heater 16 via line 48 to a plurality of externally-heated tubes 50, containing a pelleted nickel-based steam reforming catalyst, in gas-heated reformer 52. The hydrocarbons are converted to methane, hydrogen and carbon monoxide as the mixture passes over the steam reforming catalyst. The resulting steam reformed gas mixture is then fed directly via line 54 to the burner region of an autothermal reformer 56, where it is partially combusted with oxygen fed via line 58 that has been produced in an air separation unit 60, pre-heated in heat exchanger 62, and mixed with a small flow of saturated steam. The hot combusted gas mixture is then brought towards equilibrium over a fixed bed of a pelleted nickel-based steam reforming catalyst 64 disposed below the combustion zone in the autothermal reformer 56. The resulting hot reformed gas mixture is fed from the autothermal reformer 56 via line 66 to the shell side of the gas-heated reformer 52. The hot reformed gas mixture heats the external surfaces of the tubes 50 in the gas-heated reformer, thereby providing the heat for the steam reforming reactions. The resulting partially cooled reformed gas mixture is fed from the shell side of the gas-heated reformer 52 to via line 68 to the heat exchanger 38 where it is used to heat the saturator feed water 32 and form a cooled reformed gas.

The cooled reformed gas is fed from heat exchanger 38 via line 70 to catalyst-filled tubes 72 containing a particulate copper-based water-gas shift catalyst, in an isothermal shift vessel 74. The exothermic water-gas shift reaction, whereby the hydrogen content of the reformed gas is increased, and the carbon monoxide is converted to carbon dioxide, occurs as the gas passes through the catalyst filled tubes 72. The catalyst-filled tubes 72 are cooled by means of water under pressure supplied to the isothermal shift vessel 74 via line 76. A mixture of water and steam is recovered from the isothermal shift vessel 74 via line 78 connected to a steam drum 80. Water is separated from the steam in the steam drum and recirculated to the isothermal shift vessel 74.

The hydrogen-enriched reformed gas is fed from the isothermal shift reactor 74 via line 82 to a heat exchanger 84 in which it is cooled using a portion of a condensate recovered later in the process. The partially cooled gas is fed from heat exchanger 84 via line 86 to a CO₂ reboiler 88, where it is further cooled in heat exchange with a CO₂-laden absorbent liquid. The cooling lowers the temperature of the gas mixture to below the dew point so that water condenses. The cooled stream is fed from the reboiler 88 via line 90 to a gas-liquid separator 92 in which the condensate is separated from the hydrogen-enriched reformed gas mixture. A portion of the condensate stream is fed from the separator 92 via a line 94 and pump 96 to the heat exchanger 84 where it is heated. A heated condensate is recovered from the heat exchanger 84 by line 98 and mixed with steam condensate fed via line 100 to form a combined condensate. The combined condensate is mixed with the saturator bottom water in line 34 and the combined liquids fed to the saturator 30 via pump 36. By re-using the condensates, organic compounds remaining after or formed during the reforming and shift stages may be returned to the process.

Another portion of the condensate may be recovered from the separator 92 via a line 104, combined with one or more additional condensate streams and sent to water treatment.

A partially de-watered hydrogen-enriched reformed gas mixture is recovered from the separator 92 via line 106 and further cooled in heat exchange with water in heat exchanger 108 and air in cooler 110. The cooled gas is passed to a second gas-liquid separator 112 to recover a further condensate stream 114. A partially de-watered hydrogen-enriched reformed gas mixture is recovered from the separator 112 via line 116 and further cooled in heat exchange with water in heat exchanger 118. The cooled gas is passed to a third gas-liquid separator 120 to recover a further condensate stream 122. The condensate streams 114 and 122 are combined with the stream 104 and sent for water treatment via line 124.

The de-watered hydrogen-enriched reformed gas mixture is fed from the separator 120 via line 126 to a CO₂ removal unit 128, such as an acid gas recovery unit, operating with a liquid absorbent wash system that absorbs CO₂ from the gas. Absorbed CO₂ is recovered from the CO₂-laden absorbent liquid in the CO₂ removal unit 128 by reducing the pressure and heating it in a reboiler 88 using the partially cooled hydrogen-enriched gas mixture in line 86. The recovered CO₂ from the CO₂ removal unit 128 is compressed and sent for storage via line 130.

A crude hydrogen gas stream 132 is recovered from the CO₂ removal unit 128 and fed to a pressure swing adsorption unit 134 containing a porous adsorbent that traps carbon oxides and methane in the crude hydrogen, thereby producing a purified hydrogen stream. A purified hydrogen gas is recovered from the pressure swing adsorption unit 134 via line 136. A portion of the purified hydrogen is taken via line 138 and compressed to form the recirculated hydrogen stream 12. The remaining purified hydrogen is compressed and sent via line 140 either for storage, for the generation of power or heat or the synthesis of chemicals.

The pressure swing adsorption unit 134, by adjusting the pressure, desorbs the carbon oxides and methane trapped in the porous adsorbent thereby generating a fuel gas. The fuel gas is recovered from the pressure swing adsorption unit 134 via line 142. A portion of the fuel gas in line 142 is provided to the first fired heater 16 via line 18 as the sole fuel to that heater. A second portion of the fuel gas in line 142 is provided as the sole fuel to a second fired heater 144 via line 146.

The second fired heater heats water, raises steam, and generates super-heated steam for the process by the combustion of the fuel gas. A stream of de-aerated water is fed to the second fired heater 144 via line 148. The resulting heated water is divided. A portion is fed from the fired heater 144 via line 150 to the steam drum 80 coupled to the isothermal water-gas shift reactor 74. Steam is then fed from the steam drum 80 via line 42 to the saturated natural gas stream 40. Another portion of the heated water generated from line 148 is fed via line 152 to a steam drum 154. Steam for the steam drum is also provided by recirculating water via from the steam drum a line 156 through the fired heater 144. Steam recovered from the steam drum 154 is divided. A portion is taken via line 158 to heat the oxygen stream in heat exchanger 62 and then steam condensate formed from the heat exchanger 62 is sent via line 100 to supplement the condensate saturator feed in line 102. A portion of steam from line 158 is added via line 162 to the preheated oxygen stream 58 before it is sent to the autothermal reformer burner. Another portion of the steam from steam drum 154 is sent via line 160 to the fired heater 144 for further heating to produce super-heated steam that is fed to the saturated natural gas stream 40 via line 44.

The efficient use of the fuel gas to provide the heated natural gas feed streams and steam for the process minimises CO₂ emissions from the process.

The invention is further illustrated by the following calculated example of a process in accordance with the flowsheet depicted in FIG. 1.

| | | Stream Number | | | | | | |
|---|---|---|---|---|---|---|---|---|
| | | 10 | 12 | 20 | 28 | 32 | 40 | 42 |
| Molar Flow | kNm³/h | 36.4 | 0.7 | 37.2 | 37.2 | 381.7 | 106.2 | 25.1 |
| Mass Flow | t/h | 29.3 | 0.1 | 29.3 | 29.3 | 306.9 | 84.9 | 20.1 |
| Temperature | ° C. | 40 | 94 | 230 | 227 | 255 | 228 | 256 |
| Pressure | bara | 45.0 | 47.0 | 43.5 | 43.3 | 43.5 | 42.8 | 44.0 |
| Molar Composition | Unit | | | | | | | |
| Methane | mol % | 89.00 | 0.00 | 87.24 | 87.24 | 0.01 | 30.53 | 0.00 |
| Ethane | mol % | 7.00 | 0.00 | 6.86 | 6.86 | 0.00 | 2.40 | 0.00 |
| Propane | mol % | 1.00 | 0.00 | 0.98 | 0.98 | 0.00 | 0.34 | 0.00 |
| Butanes | mol % | 0.10 | 0.00 | 0.10 | 0.10 | 0.00 | 0.03 | 0.00 |
| Pentanes | mol % | 0.01 | 0.00 | 0.01 | 0.01 | 0.00 | 0.00 | 0.00 |
| Hydrogen | mol % | 0.00 | 100.00 | 1.98 | 1.98 | 0.00 | 0.69 | 0.00 |
| Carbon Dioxide | mol % | 2.00 | 0.00 | 1.96 | 1.96 | 0.02 | 0.75 | 0.00 |
| Carbon Monoxide | mol % | 0.00 | 0.00 | 0.00 | 0.00 | 0.00 | 0.00 | 0.00 |
| Oxygen | mol % | 0.00 | 0.00 | 0.00 | 0.00 | 0.00 | 0.00 | 0.00 |
| Nitrogen | mol % | 0.89 | 0.00 | 0.87 | 0.87 | 0.00 | 0.31 | 0.00 |
| Argon | mol % | 0.00 | 0.00 | 0.00 | 0.00 | 0.00 | 0.00 | 0.00 |
| Water | mol % | 0.00 | 0.00 | 0.00 | 0.00 | 99.96 | 64.92 | 100.00 |
| Methanol | mol % | 0.00 | 0.00 | 0.00 | 0.00 | 0.01 | 0.02 | 0.00 |
| Ammonia | mol % | 0.00 | 0.00 | 0.00 | 0.00 | 0.00 | 0.00 | 0.00 |

| | | Stream Number | | | | | | |
|---|---|---|---|---|---|---|---|---|
| | | 44 | 48 | 54 | 58 | 66 | 70 | 82 |
| Molar Flow | kNm³/h | 24.9 | 156.2 | 180.6 | 18.5 | 233.5 | 233.5 | 233.4 |
| Mass Flow | t/h | 20.0 | 125.1 | 125.1 | 26.2 | 151.3 | 151.3 | 151.3 |
| Temperature | ° C. | 450 | 440 | 694 | 209 | 1020 | 240 | 257 |
| Pressure | bara | 43.8 | 41.3 | 35.4 | 40.5 | 34.6 | 33.6 | 33.1 |
| Molar Composition | | | | | | | | |
| Methane | mol % | 0.00 | 20.75 | 14.71 | 0.00 | 0.14 | 0.14 | 0.14 |
| Ethane | mol % | 0.00 | 1.63 | 0.00 | 0.00 | 0.00 | 0.00 | 0.00 |
| Propane | mol % | 0.00 | 0.23 | 0.00 | 0.00 | 0.00 | 0.00 | 0.00 |
| Butanes | mol % | 0.00 | 0.02 | 0.00 | 0.00 | 0.00 | 0.00 | 0.00 |
| Pentanes | mol % | 0.00 | 0.00 | 0.00 | 0.00 | 0.00 | 0.00 | 0.00 |
| Hydrogen | mol % | 0.00 | 0.47 | 23.98 | 0.00 | 38.89 | 38.89 | 48.87 |
| Carbon Dioxide | mol % | 0.00 | 0.51 | 5.62 | 0.00 | 6.46 | 6.46 | 16.48 |
| Carbon Monoxide | mol % | 0.00 | 0.00 | 1.58 | 0.00 | 10.35 | 10.35 | 0.32 |
| Oxygen | mol % | 0.00 | 0.00 | 0.00 | 97.83 | 0.00 | 0.00 | 0.00 |
| Nitrogen | mol % | 0.00 | 0.21 | 0.18 | 0.49 | 0.18 | 0.18 | 0.18 |
| Argon | mol % | 0.00 | 0.00 | 0.00 | 0.00 | 0.00 | 0.00 | 0.00 |
| Water | mol % | 100.00 | 76.15 | 53.92 | 1.68 | 43.98 | 43.98 | 33.99 |
| Methanol | mol % | 0.00 | 0.01 | 0.00 | 0.00 | 0.00 | 0.00 | 0.02 |
| Ammonia | mol % | 0.00 | 0.00 | 0.00 | 0.00 | 0.00 | 0.00 | 0.00 |

| | | Stream Number | | | | | | |
|---|---|---|---|---|---|---|---|---|
| | | 90 | 100 | 98 | 106 | 116 | 124 | 126 |
| Molar Flow | kNm³/h | 233.4 | 3.4 | 67.3 | 165.1 | 155.8 | 11.7 | 154.3 |
| Mass Flow | t/h | 151.3 | 2.7 | 54.2 | 96.3 | 88.8 | 9.5 | 87.7 |
| Temperature | ° C. | 120 | 255 | 180 | 120 | 71 | 71 | 40 |
| Pressure | bara | 32.1 | 43.5 | 43.5 | 32.1 | 31.4 | 31.1 | 31.1 |
| Molar Composition | | | | | | | | |
| Methane | mol % | 0.14 | 0.00 | 0.00 | 0.19 | 0.21 | 0.00 | 0.21 |
| Ethane | mol % | 0.00 | 0.00 | 0.00 | 0.00 | 0.00 | 0.00 | 0.00 |
| Propane | mol % | 0.00 | 0.00 | 0.00 | 0.00 | 0.00 | 0.00 | 0.00 |
| Butanes | mol % | 0.00 | 0.00 | 0.00 | 0.00 | 0.00 | 0.00 | 0.00 |
| Pentanes | mol % | 0.00 | 0.00 | 0.00 | 0.00 | 0.00 | 0.00 | 0.00 |
| Hydrogen | mol % | 48.87 | 0.00 | 0.00 | 69.08 | 73.22 | 0.00 | 73.89 |
| Carbon Dioxide | mol % | 16.48 | 0.00 | 0.10 | 23.26 | 24.64 | 0.14 | 24.87 |
| Carbon Monoxide | mol % | 0.32 | 0.00 | 0.00 | 0.45 | 0.48 | 0.00 | 0.48 |
| Oxygen | mol % | 0.00 | 0.00 | 0.00 | 0.00 | 0.00 | 0.00 | 0.00 |
| Nitrogen | mol % | 0.18 | 0.00 | 0.00 | 0.25 | 0.26 | 0.00 | 0.27 |
| Argon | mol % | 0.00 | 0.00 | 0.00 | 0.00 | 0.00 | 0.00 | 0.00 |
| Water | mol % | 33.99 | 100.00 | 99.86 | 6.75 | 1.17 | 99.72 | 0.27 |
| Methanol | mol % | 0.02 | 0.00 | 0.03 | 0.02 | 0.02 | 0.12 | 0.01 |
| Ammonia | mol % | 0.00 | 0.00 | 0.01 | 0.00 | 0.00 | 0.02 | 0.00 |

| | | Stream Number | | | | | | | |
|---|---|---|---|---|---|---|---|---|---|
| | | 130 | 132 | 140 | 142 | 148 | 150 | 158 | 160 |
| Molar Flow | kNm³/h | 38.4 | 115.8 | 100.5 | 14.6 | 57.2 | 25.5 | 3.7 | 24.9 |
| Mass Flow | t/h | 75.3 | 12.3 | 9.0 | 3.2 | 45.8 | 20.5 | 3.0 | 20.0 |
| Temperature | ° C. | 1 | 49 | 10 | 40 | 107 | 235 | 256 | 256 |
| Pressure | bara | 21.0 | 31.1 | 46.0 | 1.5 | 47.0 | 46.5 | 44.0 | 44.0 |
| Molar Composition | | | | | | | | | |
| Methane | mol % | 0.00 | 0.28 | 0.00 | 2.19 | 0.00 | 0.00 | 0.00 | 0.00 |
| Ethane | mol % | 0.00 | 0.00 | 0.00 | 0.00 | 0.00 | 0.00 | 0.00 | 0.00 |
| Propane | mol % | 0.00 | 0.00 | 0.00 | 0.00 | 0.00 | 0.00 | 0.00 | 0.00 |
| Butanes | mol % | 0.00 | 0.00 | 0.00 | 0.00 | 0.00 | 0.00 | 0.00 | 0.00 |
| Pentanes | mol % | 0.00 | 0.00 | 0.00 | 0.00 | 0.00 | 0.00 | 0.00 | 0.00 |
| Hydrogen | mol % | 0.21 | 98.43 | 100.00 | 87.56 | 0.00 | 0.00 | 0.00 | 0.00 |
| Carbon Dioxide | mol % | 99.74 | 0.04 | 0.00 | 0.32 | 0.00 | 0.00 | 0.00 | 0.00 |
| Carbon Monoxide | mol % | 0.00 | 0.64 | 0.00 | 5.09 | 0.00 | 0.00 | 0.00 | 0.00 |
| Oxygen | mol % | 0.00 | 0.00 | 0.00 | 0.00 | 0.00 | 0.00 | 0.00 | 0.00 |
| Nitrogen | mol % | 0.00 | 0.36 | 0.00 | 2.82 | 0.00 | 0.00 | 0.00 | 0.00 |
| Argon | mol % | 0.00 | 0.00 | 0.00 | 0.00 | 0.00 | 0.00 | 0.00 | 0.00 |
| Water | mol % | 0.05 | 0.23 | 0.00 | 1.82 | 100.00 | 100.00 | 100.00 | 100.00 |
| Methanol | mol % | 0.00 | 0.02 | 0.00 | 0.16 | 0.00 | 0.00 | 0.00 | 0.00 |
| Ammonia | mol % | 0.00 | 0.00 | 0.00 | 0.03 | 0.00 | 0.00 | 0.00 | 0.00 |

The flowsheet allows for capture of about 97% CO₂ at a steam to carbon ratio of 3.1:1.

1.-21. (canceled)

22. A process for the production of hydrogen comprising the steps of:
(i) subjecting a gaseous mixture comprising a hydrocarbon and steam, and having a steam to carbon ratio of at least 2.6:1, to steam reforming in a gas-heated reformer followed by autothermal reforming with an oxygen-rich gas in an autothermal reformer to generate a reformed gas mixture,
(ii) increasing the hydrogen content of the reformed gas mixture by subjecting it to one or more water-gas shift stages in a water-gas shift unit to provide a hydrogen-enriched reformed gas,
(iii) cooling the hydrogen-enriched reformed gas and separating condensed water therefrom,
(iv) passing the resulting de-watered hydrogen-enriched reformed gas to a carbon dioxide separation unit to provide a carbon dioxide gas stream and a crude hydrogen gas stream, and
(v) passing the crude hydrogen gas stream to a purification unit to provide a purified hydrogen gas and a fuel gas,
wherein the fuel gas is fed, as the sole fuel, to one or more fired heaters used to heat one or more process streams within the process.

23. The process according to claim 22, wherein the hydrocarbon is a methane-containing gas stream, preferably containing >50% vol of methane.

24. The process according to claim 22, wherein the hydrocarbon is desulphurised.

25. The process according to claim 22, wherein the steam to carbon ratio is in the range 2.8:1 to 3.5:1, preferably 2.9:1 to 3.2:1 or 3.2:1 to 3.5:1.

26. The process according to claim 22, wherein the gaseous mixture comprising the hydrocarbon and steam is formed by contacting the hydrocarbon with water in a saturator to form a saturated gas mixture, with optional direct addition of steam to the saturated gas mixture.

27. The process according to claim 22, wherein the water fed to the saturator is heated in heat exchange with the reformed gas mixture.

28. The process according to claim 22, wherein the oxygen-rich gas comprises at least 90% vol O₂, preferably at least 95% vol O₂, more preferably at least 98% vol O₂.

29. The process according to claim 22, wherein the water-gas shift stage comprises an isothermal shift stage and optionally a downstream low-temperature shift stage.

30. The process according to claim 22, wherein there are two or three stages of cooling and separation of process condensate before the carbon dioxide removal stage.

31. The process according to claim 22, wherein the carbon dioxide removal stage is performed using a physical wash system or a reactive wash system, preferably a reactive wash system, especially an amine wash system.

32. The process according to claim 22, wherein one or more of the carbon dioxide removal unit streams are heated in heat exchange with the hydrogen-enriched reformed gas stream.

33. The process according to claim 22, wherein the purification unit is a pressure swing adsorption unit or a temperature swing adsorption unit, preferably a pressure swing adsorption unit.

34. The process according to claim 22, wherein the carbon dioxide recovered from the carbon dioxide removal unit and the purified hydrogen gas recovered from the purification unit are each compressed in electrically-driven compressors.

35. The process according to claim 22, wherein a portion of the crude hydrogen or pure hydrogen is fed to the hydrocarbon.

36. The process according to claim 22, wherein there are two fired heaters fuelled by the fuel gas recovered from the purification unit; a first fired heater that heats the hydrocarbon and/or the gaseous mixture of hydrocarbon and steam, and a second fired heater that functions as a boiler to generate steam for the process.

37. The process according to claim 36 wherein the fuel gas split to the first and second fired heaters in the ranges of 10-90% vol to 90-10% vol respectively, preferably 40-50% vol to the first fired heater and 60-50% vol to the second fired heater.

38. The process according to claim 36, wherein a portion of the steam generated in the second fired heater is used in the gaseous mixture fed to the gas-heated reformer.

39. The process according to claim 36, wherein steam generated in the second fired heater is provided via a steam drum coupled to an isothermal shift converter.

40. The process according to claim 39 wherein the entire steam for the process is generated by a combination of a saturator, the second fired heater and by a steam drum coupled to the isothermal shift converter.

41. The process according to claim 40 wherein the saturator generates 50-60% or 55-65% of the steam, the second fired heater raises 20-25% of the steam and the steam drum coupled to the isothermal shift converter raises the balance.

42. The process according to claim 22 wherein the pure hydrogen stream is used in a downstream power process, heating process, a downstream chemical synthesis process or used to upgrade hydrocarbons.
